(19) United States
(12) Patent Application Publication
(10) Pub. No.: US 2026/0128333 A1
(43) Pub. Date: May 7, 2026

(54) FUEL CELL

(71) Applicants: Hyundai Motor Company, Seoul (KR); Kia Corporation, Seoul (KR)

(72) Inventor: Jae Bum Lim, Hwaseong (KR)

(21) Appl. No.: 19/057,485

(22) Filed: Feb. 19, 2025

(30) Foreign Application Priority Data
Nov. 4, 2024 (KR) 10-2024-0154397

(51) Int. Cl. H01M 8/04082; B60L 50/71; F16K 17/04; H01M 8/04007; H01M 8/04089; H01M 8/2457; H01M 8/2484

(52) U.S. Cl. CPC H01M 8/04201; F16K 17/04; H01M 8/04067; H01M 8/04089; H01M 8/2457; H01M 8/2484; B60L 50/71; H01M 2250/20

(57) ABSTRACT

A fuel cell is described that uses a movable overpressure prevention unit to automatically narrow the fluid flow path when internal pressure exceeds a safe limit. The system includes a cell stack for power generation, a fluid supply unit, and conduits directing air, hydrogen, or coolant to the stack. An overpressure prevention member is biased by an elastic element so it remains out of the flow under normal conditions. At higher pressure, it moves into the path, limiting the cross-sectional area and lowering pressure. A variant employs an extension bracket between separate conduits, replacing a standard hose bracket while integrating the same protective mechanism. Additionally, a method is disclosed in which an extension bracket with an overpressure prevention member helps prevent damage to components by automatically engaging when fluid pressure surpasses a set threshold.

This application claims under 35 U.S.C. § 119(a) the benefit of Korean Patent Application No. 10-2024-0154397, filed on Nov. 4, 2024, which is hereby incorporated by reference as if fully set forth herein.

### BACKGROUND

### Technical Field

Embodiments relate to a fuel cell.

### Background

A fuel cell receives hydrogen and air to generate power, and maintains an appropriate temperature for power generation using coolant. In order to deliver fluids such as hydrogen, air, and coolant to an outlet of the fuel cell, high fluid pressure is required.

Hydrogen stored in a hydrogen tank is supplied with the pressure thereof lowered, air is supplied with the pressure thereof increased by an air compressor, and coolant is supplied with the pressure thereof increased by a compressor.

If components of a fuel cell are exposed to high-pressure fluid, the components may be degraded, and the performance of the fuel cell may deteriorate. In order to prevent this, a pressure sensor is disposed in a flow path, and a compressor is controlled based on the pressure detected by the pressure sensor. However, this configuration is not sufficient to protect components of a fuel cell from high-pressure fluid. Therefore, research with the goal of solving the above problem is underway.

### SUMMARY

Accordingly, embodiments are directed to a fuel cell that substantially obviates one or more problems due to limitations and disadvantages of the related art.

Embodiments provide a fuel cell capable of protecting components thereof from high pressure of fluid.

However, the objects to be accomplished by the embodiments are not limited to the above-mentioned objects, and other objects not mentioned herein will be clearly understood by those skilled in the art from the following description.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

A fuel cell according to some embodiments may include a cell stack including a plurality of unit cells stacked one above another, a fluid management unit configured to supply a fluid required for generation of power by the cell stack, a pipe disposed between the fluid management unit and the cell stack to form a flow path through which the fluid flows, and an overpressure prevention unit disposed in the pipe to regulate the area of the flow path in accordance with the hydraulic pressure of the fluid.

In an aspect, a fuel cell is provided that comprises: 1) a cell stack configured to generate electric power from electrochemical reactions; 2) a fluid management unit configured to supply a fluid to the cell stack; 3) a conduit defining a flow path for the fluid between the fluid management unit and the cell stack; and 4) an overpressure prevention unit disposed in the pipe and configured to regulate a cross-sectional area of the flow path in response to a hydraulic pressure of the fluid.

In an example, the overpressure prevention unit may include a protruding portion protruding outward from the pipe to define an accommodation space at least partially communicating with the flow path, an overpressure prevention member disposed in the accommodation space so as to receive the hydraulic pressure of the fluid flowing through the pipe, an elastic member disposed in the accommodation space to apply spring force to the overpressure prevention member in a direction opposite the flow direction of the fluid, and a support member configured to support the overpressure prevention member. The overpressure prevention member may be shaped to at least partially move to the flow path from the accommodation space in order to reduce the area of the flow path when the hydraulic pressure received by the overpressure prevention member is greater than the spring force.

In an example, the overpressure prevention member may include a first side surface formed to be in contact with the elastic member, a second side surface formed to be opposite the first side surface, to be in contact with the support member, and to receive the hydraulic pressure, and a third side surface formed between the first side surface and the second side surface and having an inclined cross-section. When the overpressure prevention member is pushed toward the elastic member by the fluid, a corner portion at which the first side surface and the third side surface meet each other may enter the flow path, thereby reducing the area of the flow path.

In an aspect, the overpressure prevention unit comprises: 1) a protruding portion extending outward from the conduit and defining an accommodation space in fluid communication with the flow path, 2) an overpressure prevention member movably disposed within the accommodation space, 3) a support member configured to retain the overpressure prevention member in the accommodation space unless displaced by a predetermined fluid pressure, and 4) an elastic member biased against the overpressure prevention member in a direction opposite the fluid flow, such that when the fluid pressure exceeds the biasing force of the elastic member, at least part of the overpressure prevention member moves into the flow path to reduce the cross-sectional area.

In an example, the fluid management unit may include an air processing system configured to manage inflow and outflow of air into and from the cell stack, a fuel processing system configured to manage inflow and outflow of hydrogen into and from the cell stack, and a thermal management system configured to manage inflow and outflow of a cooling medium into and from the cell stack. The pipe may include an air pipe disposed between the air processing system and the cell stack, a hydrogen pipe disposed between the fuel processing system and the cell stack, and a cooling pipe disposed between the thermal management system and the cell stack.

In an example, the overpressure prevention unit may be disposed in at least one of the air pipe, the hydrogen pipe, or the cooling pipe.

In an example, the pipe may include a plurality of separate pipes, and the overpressure prevention unit may be disposed between the plurality of separate pipes to interconnect the plurality of separate pipes.

In an example, the overpressure prevention unit may include first and second overpressure prevention units disposed opposite each other with the flow path interposed therebetween in a direction intersecting the flow direction of the fluid.

In an example, the first and second overpressure prevention units may have cross-sectional shapes symmetrical to each other with respect to the flow path.

In an example, the elastic member may have a coefficient of elasticity allowing the elastic member to be compressed by the overpressure prevention member when the hydraulic pressure is higher than a first predetermined pressure.

In an example, the overpressure prevention member may linearly or nonlinearly reduce the area of the flow path in proportion to the hydraulic pressure received thereby.

In an example, the accommodation space may include a first accommodation space communicating with the flow path and accommodating the overpressure prevention member and a second accommodation space neighboring the first accommodation space and accommodating the elastic member.

In an example, the fuel cell may further include a blocking portion disposed between the flow path and the second accommodation space to block the fluid from flowing into the second accommodation space.

In some embodiments, a fuel cell comprises a cell stack configured to generate electric power from electrochemical reactions, a fluid management unit configured to supply a fluid to the cell stack, a conduit defining a flow path for the fluid between the fluid management unit and the cell stack, and an overpressure prevention unit disposed in the conduit and configured to regulate a cross-sectional area of the flow path in response to a hydraulic pressure of the fluid. The overpressure prevention unit may comprise a protruding portion extending outward from the conduit and defining an accommodation space in fluid communication with the flow path, an overpressure prevention member movably disposed within the accommodation space, a support member configured to retain the overpressure prevention member in the accommodation space unless displaced by a predetermined fluid pressure, and an elastic member biased against the overpressure prevention member in a direction opposite the fluid flow, such that when the fluid pressure exceeds the biasing force of the elastic member, at least part of the overpressure prevention member moves into the flow path to reduce the cross-sectional area. The overpressure prevention member may include a first side surface being in contact with the support member and receiving the hydraulic pressure, a second side surface formed opposite the first side surface and in contact with the elastic member, and a third side surface formed between the first and second side surfaces, the third side surface having an inclined cross-section. When the overpressure prevention member is pushed toward the elastic member by the fluid, a corner portion at which the second side surface and the third side surface meet may enter the flow path, thereby reducing the cross-sectional area of the flow path. The fluid management unit may include an air processing system configured to manage inflow and outflow of air into and from the cell stack, a fuel processing system configured to manage inflow and outflow of hydrogen into and from the cell stack, and a thermal management system configured to manage inflow and outflow of a cooling medium into and from the cell stack, and the conduit may include an air conduit disposed between the air processing system and the cell stack, a hydrogen conduit disposed between the fuel processing system and the cell stack, and a cooling conduit disposed between the thermal management system and the cell stack. The overpressure prevention unit may be disposed in at least one of the air conduit, the hydrogen conduit, or the cooling conduit. The conduit may include a plurality of separate conduits, and the overpressure prevention unit may be disposed between the plurality of separate conduits to interconnect them. The overpressure prevention unit may include first and second overpressure prevention units disposed opposite each other with the flow path interposed therebetween in a direction intersecting a flow direction of the fluid, and those first and second overpressure prevention units may have cross-sectional shapes symmetrical to each other with respect to the flow path. The elastic member may have an elasticity allowing it to be compressed by the overpressure prevention member when the hydraulic pressure is higher than a first predetermined pressure. The overpressure prevention member may linearly reduce the cross-sectional area of the flow path in proportion to the hydraulic pressure received, or may reduce the cross-sectional area in a nonlinear manner in proportion to the hydraulic pressure. The accommodation space may include a first accommodation space communicating with the flow path and accommodating the overpressure prevention member, and a second accommodation space neighboring the first accommodation space and accommodating the elastic member. A blocking portion may be disposed between the flow path and the second accommodation space to block the fluid from flowing into the second accommodation space.

In some embodiments, a fuel cell system comprises a cell stack configured to generate electric power from electrochemical reactions, a fluid management unit configured to supply at least one fluid to the cell stack, a first fluid conduit and a second fluid conduit arranged to direct the at least one fluid, and an extension bracket fluidly coupling the first fluid conduit to the second fluid conduit. The extension bracket integrates an overpressure prevention structure that may include an overpressure prevention member configured to protrude into a flow path through the bracket in response to fluid pressure exceeding a predetermined threshold, and an elastic member applying a biasing force that retains the overpressure prevention member outside the flow path during normal operating pressure. The extension bracket may replace a conventional hose bracket, thereby reducing the need for a separate bracket to connect the first fluid conduit and the second fluid conduit. The overpressure prevention structure may further comprise a guide portion configured to restrain the overpressure prevention member from inadvertently shifting into the flow path when fluid pressure is below the predetermined threshold. The overpressure prevention structure may be applied to any one or more of hydrogen flow, air flow, or coolant flow within the fuel cell system. A vehicle body may support the cell stack, and the extension bracket may be disposed along at least one fluid line supplying the cell stack within the vehicle.

In some embodiments, a method of preventing overpressure in a fuel cell system comprises disposing, between a fluid management unit and a cell stack, an overpressure prevention unit having an overpressure prevention member and an elastic member arranged in an extension bracket that interconnects two fluid conduits, maintaining the overpressure prevention member out of a fluid flow path when fluid pressure is below a predetermined threshold, and automatically reducing a cross-sectional area of the fluid flow path by allowing the overpressure prevention member to protrude into the flow path when the fluid pressure exceeds the predetermined threshold. A spring constant for the elastic member may be selected based on the predetermined threshold such that the overpressure prevention member remains fully retracted during normal operating conditions and only protrudes into the flow path upon detecting the predetermined overpressure condition.

As discussed, the method and system suitably include use of a controller or processer.

In another embodiment, vehicles are provided that comprise an apparatus as disclosed herein.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a cross-sectional view of end plates and a cell stack of a general fuel cell;

FIG. 2 is a block diagram of a fuel cell according to some embodiments;

FIG. 3 is a conceptual view of an overpressure prevention unit according to some embodiments;

FIG. 4A is a view showing a state in which first and second overpressure prevention members are not introduced into a flow path;

FIG. 4B is a view showing a state in which the first and second overpressure prevention members are introduced into the flow path;

FIGS. 5A and 5B are views for explaining the principle of reduction in pressure by the overpressure prevention unit according to the embodiment; and

FIGS. 6A and 6B are views for explaining an application example of the overpressure prevention unit according to the embodiment.

### DETAILED DESCRIPTION OF THE DISCLOSURE

The present disclosure will now be described more fully hereinafter with reference to the accompanying drawings, in which various embodiments are shown. The examples, however, may be embodied in many different forms, and should not be construed as being limited to the embodiments set forth herein. Rather, these embodiments are provided so that this disclosure will be more thorough and complete, and will more fully convey the scope of the disclosure to those skilled in the art.

The term “fuel cell” used herein refers to an electrochemical device that converts the chemical energy of a fuel (often hydrogen) and an oxidizer (often oxygen from air) into electricity through electrochemical reactions.

The term “flow path” used herein refers to a passage, channel, or conduit through which a fluid travels from one component to another.

The term “hydraulic pressure” used herein refers to the pressure exerted by a fluid upon a surface, measured in units such as Pascals or bar, that acts on the walls of a conduit or container.

The term “extension bracket” used herein refers to a structural component configured to fluidly couple two separate conduits or hoses together, which may also integrate additional functionality such as overpressure protection.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

A fuel cell according to some embodiments may be, for example, a polymer electrolyte membrane fuel cell (or proton exchange membrane fuel cell) (PEMFC), which has been studied most extensively as a power source for driving vehicles. However, the embodiments are not limited to any specific type of fuel cell.

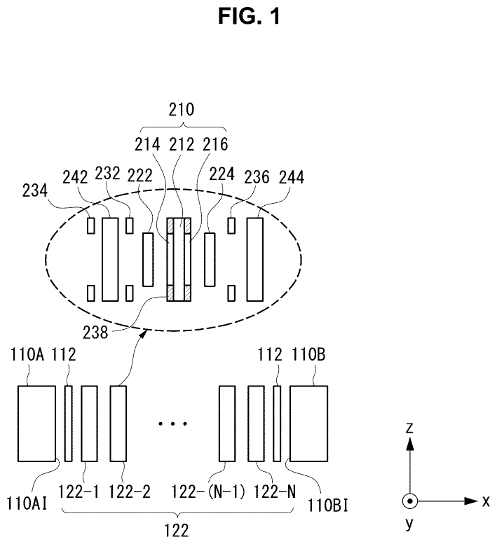

Hereinafter, an example of a fuel cell according to some embodiments will be described with reference to FIG. 1. The fuel cell will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the embodiments are not limited thereto. That is, the x-axis, the y-axis, and the z-axis may intersect each other obliquely.

FIG. 1 is a cross-sectional view of end plates and a cell stack of a general fuel cell.

The general fuel cell shown in FIG. 1 may include end plates (pressing plates or compression plates) 110A and 110B and a cell stack 122.

The cell stack 122 may include a plurality of unit cells 122-1 to 122-N, which are stacked in a first direction. Here, “N” is a positive integer of 1 or greater, and may range from several tens to several hundreds. However, the embodiments are not limited to any specific value of “N”.

Each unit cell 122-n may generate 0.6 volts to 1.0 volt of electricity, on average 0.7 volts of electricity. Here, 1≤n≤N. “N” may be determined depending on the intensity of the power to be supplied from the fuel cell to a load. Here, the load refers to a part of a vehicle that requires power when the fuel cell is used in the vehicle.

Each unit cell 122-n may include a membrane electrode assembly (MEA) 210, gas diffusion layers (GDLs) 222 and 224, gaskets 232, 234, and 236, and separators (or bipolar plates) 242 and 244.

The membrane electrode assembly 210 has a structure in which catalyst electrode layers, in which electrochemical reaction occurs, are attached to both sides of an electrolyte membrane through which hydrogen ions move. In detail, the membrane electrode assembly 210 may include a polymer electrolyte membrane (or a proton exchange membrane) 212, a fuel electrode (a hydrogen electrode or an anode) 214, and an air electrode (an oxygen electrode or a cathode) 216. In addition, the membrane electrode assembly 210 may further include a sub-gasket 238.

The polymer electrolyte membrane 212 is disposed between the fuel electrode 214 and the air electrode 216.

Hydrogen, which is fuel in the fuel cell, may be supplied to the fuel electrode 214 through the first separator 242, and air containing oxygen as an oxidizer may be supplied to the air electrode 216 through the second separator 244. In this way, the first and second separators 242 and 244 may serve as passages that supply a reducing gas and an oxidizing gas to the cells.

The hydrogen supplied to the fuel electrode 214 is decomposed into hydrogen ions (protons) (H+) and electrons (e−) by the catalyst. Only the hydrogen ions may be selectively transferred to the air electrode 216 through the polymer electrolyte membrane 212, and at the same time, the electrons may be transferred to the air electrode 216 through the separators 242 and 244, which are conductors. In order to realize the above operation, a catalyst layer may be applied to each of the fuel electrode 214 and the air electrode 216. The movement of the electrons described above causes the electrons to flow through an external wire, thus generating current. That is, the fuel cell may generate power due to the electrochemical reaction between hydrogen, which is fuel, and oxygen contained in the air.

In the air electrode 216, the hydrogen ions supplied through the polymer electrolyte membrane 212 and the electrons transferred through the separators 242 and 244 meet oxygen in the air supplied to the air electrode 216, thus causing a reaction that generates water (“condensed water” or “product water”).

In some cases, the fuel electrode 214 may be referred to as an anode, and the air electrode 216 may be referred to as a cathode. Alternatively, the fuel electrode 214 may be referred to as a cathode, and the air electrode 216 may be referred to as an anode.

The gas diffusion layers 222 and 224 serve to uniformly distribute hydrogen and oxygen, which are reactant gases, and to transfer the generated electrical energy. To this end, the gas diffusion layers 222 and 224 may be disposed on respective sides of the membrane electrode assembly 210. That is, the first gas diffusion layer 222 may be disposed on the left side of the fuel electrode 214, and the second gas diffusion layer 224 may be disposed on the right side of the air electrode 216.

The first gas diffusion layer 222 may serve to diffuse and uniformly distribute hydrogen supplied as a reactant gas through the first separator 242, and may be electrically conductive. The second gas diffusion layer 224 may serve to diffuse and uniformly distribute air supplied as a reactant gas through the second separator 244, and may be electrically conductive.

The gaskets 232, 234, and 236 may serve to maintain airtightness and clamping pressure of the cell stack at an appropriate level with respect to the reactant gases and the coolant, to disperse the stress when the separators 242 and 244 are stacked, and to independently seal the flow paths. As such, since airtightness and watertightness are maintained by the gaskets 232, 234, and 236, the flatness of the surfaces that are adjacent to the cell stack 122, which generates power, may be secured, and thus surface pressure may be distributed uniformly over the reaction surface of the cell stack 122. To this end, the gaskets 232, 234, and 236 may be formed of rubber. However, the embodiments are not limited to any specific material of the gaskets.

The separators 242 and 244 may serve to move the reactant gases and the cooling medium and to separate each of the unit cells from the other unit cells. In addition, the separators 242 and 244 may serve to structurally support the membrane electrode assembly 210 and the gas diffusion layers 222 and 224 and to collect the generated current and transfer the collected current to current collectors 112. In this way, the separators 242 and 244 may serve as passages that move the generated current.

The separators 242 and 244 may be disposed outside the gas diffusion layers 222 and 224, respectively. That is, the first separator 242 may be disposed on the left side of the first gas diffusion layer 222, and the second separator 244 may be disposed on the right side of the second gas diffusion layer 224.

The first separator 242 serves to supply hydrogen as a reactant gas to the fuel electrode 214 through the first gas diffusion layer 222. The second separator 244 serves to supply air as a reactant gas to the air electrode 216 through the second gas diffusion layer 224. In addition, each of the first and second separators 242 and 244 may form a channel through which a cooling medium (e.g. coolant) may flow. Further, the separators 242 and 244 may be formed of a graphite-based material, a composite graphite-based material, or a metal-based material. However, the embodiments are not limited to any specific material of the separators 242 and 244.

The end plates 110A and 110B shown in FIG. 1 may be disposed at the respective ends of the cell stack 122, and may support and fix the unit cells 122. That is, the first end plate 110A may be disposed at one end of the cell stack 122, and the second end plate 110B may be disposed at the opposite end of the cell stack 122.

Each of the end plates 110A and 110B may be configured such that a metal insert is surrounded by a plastic injection-molded product. The metal insert of each of the end plates 110A and 110B may have high rigidity to withstand internal surface pressure, and may be formed by machining a metal material. For example, each of the end plates 110A and 110B may be formed by combining a plurality of plates. However, the embodiments are not limited to any specific configuration of the end plates 110A and 110B.

The current collectors 112 may be disposed between the cell stack 122 and the inner surfaces 110AI and 110BI of the end plates 110A and 110B that face the cell stack 122. The current collectors 112 serve to collect the electrical energy generated by the flow of electrons in the cell stack 122 and to supply the electrical energy to a load that uses the fuel cell.

Further, the first end plate 110A may include a plurality of manifolds (or communicating portions). Each of the first and second separators 242 and 244 shown in FIG. 1 may include manifolds that are formed in the same shape at the same positions as the manifolds of the first end plate 110A. Here, the manifolds may include an inlet manifold and an outlet manifold. Hydrogen and oxygen, which are reactant gases necessary in the membrane electrode assembly 210, may be introduced from the outside into the cell stack 122 through the inlet manifold. Gas or liquid, in which the reactant gases humidified and supplied to the cell and the condensed water generated in the cell are combined, may be discharged to the outside of the fuel cell through the outlet manifold. The cooling medium may flow from the outside into the cell stack 122 through the inlet manifold and may flow from the cell stack 122 to the outside through the outlet manifold. As described above, the manifolds allow the fluid to flow into and out of the membrane electrode assembly 210.

Hereinafter, a fuel cell 300 according to some embodiments will be described with reference to the accompanying drawings.

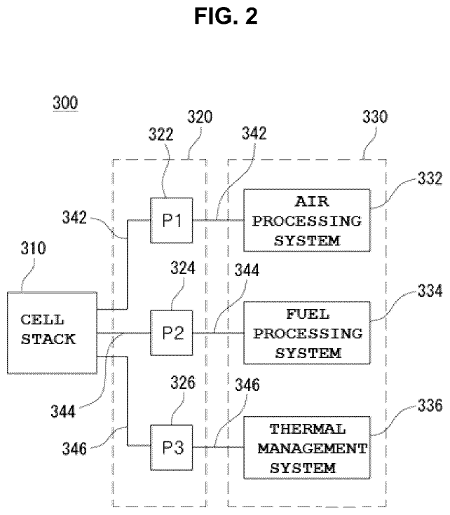

FIG. 2 is a block diagram of a fuel cell 300 according to some embodiments. The fuel cell 300 according to the embodiment may include a cell stack 310, an overpressure prevention unit 320, a fluid management unit 330, and pipes 342, 344, and 346.

The cell stack 310 shown in FIG. 2 may correspond to the cell stack 122 shown in FIG. 1, but the embodiments are not limited thereto. That is, the fuel cell 300 according to the embodiment is not limited to any specific structure of the cell stack, and may include various cell stacks 122 configured differently from the cell stack 122 shown in FIG. 1.

The fluid management unit 330 serves to supply a fluid required for generation of power by the cell stack 310. As described above with reference to FIG. 1, fluids such as air, hydrogen, and a cooling medium are required for power generation.

For example, as shown in FIG. 1, the fluid management unit 330 may include an air processing system (APS) (or air supply system) 332, a fuel processing system (FPS) (or fuel supply system) 334, and a thermal management system (TMS) (or cooling medium processing system) 336.

The APS 332 serves to manage inflow and outflow of air into and from the cell stack 310. That is, the APS 332 manages inflow and outflow of air containing oxygen between the outside and the cell stack 310. That is, the APS 332 serves to introduce air containing oxygen into the cell stack 310 from the outside and to discharge oxygen as a reactant gas and condensed water flowing out of the cell stack 310 to the outside.

The FPS 334 serves to manage inflow and outflow of hydrogen into and from the cell stack 310. That is, the FPS 334 manages inflow and outflow of hydrogen into and from the cell stack 310. To this end, the FPS 334 serves to introduce hydrogen into the cell stack 310 from the outside and to discharge hydrogen as a reactant gas and condensed water flowing out of the cell stack 310 to the outside.

The TMS 336 serves to manage inflow and outflow of a cooling medium (e.g., coolant) into and from the cell stack 310. That is, the TMS 336 manages inflow and outflow of the cooling medium into and from the cell stack 310. To this end, the TMS 336 serves to introduce the cooling medium into the cell stack 310 and to discharge the cooling medium flowing out of the cell stack 310 to the outside.

The fluid management unit 330 may be a part that handles a fluid among peripheral auxiliary parts of the fuel cell, such as the APS 332, the FPS 334, or the TMS 336. However, the fluid management unit 330 is not limited to the above-described example.

Referring again to FIG. 2, the pipes 342, 344, and 346 are disposed between the fluid management unit 330 and the cell stack 310 to form flow paths through which fluids flow. That is, the pipes may include an air pipe 342, a hydrogen pipe 344, and a cooling pipe 346.

The air pipe 342 is disposed between the APS 332 and the cell stack 310 to form a flow path through which air flows.

The hydrogen pipe 344 is disposed between the FPS 334 and the cell stack 310 to form a flow path through which hydrogen flows.

The cooling pipe 346 is disposed between the TMS 336 and the cell stack 310 to form a flow path through which a cooling medium flows.

The overpressure prevention unit 320 is disposed in the pipe to regulate the area of the flow path in accordance with the hydraulic pressure of the fluid. The overpressure prevention unit 320 may be disposed in at least one of the air pipe 342, the hydrogen pipe 344, or the cooling pipe 346. For example, as shown in FIG. 2, the overpressure prevention unit 320 may include an air overpressure prevention unit P1 (322) disposed in the air pipe 342, a hydrogen overpressure prevention unit P2 (324) disposed in the hydrogen pipe 344, and a cooling overpressure prevention unit P3 (326) disposed in the cooling pipe 346.

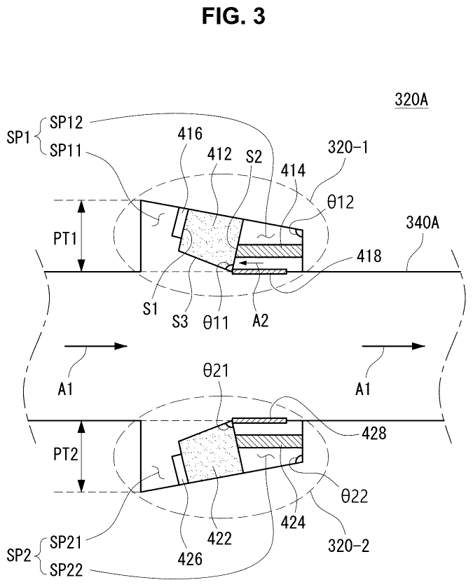

FIG. 3 is a conceptual view of an overpressure prevention unit 320A according to some embodiments.

The overpressure prevention unit 320A shown in FIG. 3 corresponds to some embodiments of each of the air overpressure prevention unit P1 (322), the hydrogen overpressure prevention unit P2 (324), and the cooling overpressure prevention unit P3 (326) included in the overpressure prevention unit 320 shown in FIG. 2.

According to the embodiment, the overpressure prevention unit 320A may include first and second overpressure prevention units 320-1 and 320-2. The first and second overpressure prevention units 320-1 and 320-2 may be disposed opposite each other with the flow path of a pipe 340A interposed therebetween in a direction intersecting the flow direction A1 of a fluid.

In addition, the first and second overpressure prevention units 320-1 and 320-2 may have cross-sectional shapes symmetrical to each other with respect to the flow path.

The pipe 340A shown in FIG. 3 may correspond to any one of the pipes 342, 344, and 346 shown in FIG. 2.

The first overpressure prevention unit 320-1 shown in FIG. 3 may include a first protruding portion PT1, a first overpressure prevention member 412, a first elastic member 414, and a first support member 416, and the second overpressure prevention unit 320-2 may include a second protruding portion PT2, a second overpressure prevention member 422, a second elastic member 424, and a second support member 426. In addition, the first overpressure prevention unit 320-1 may further include a first blocking portion 418, and the second overpressure prevention unit 320-2 may further include a second blocking portion 428.

Because the first overpressure prevention unit 320-1 and the second overpressure prevention unit 320-2 are symmetrical to each other, the first overpressure prevention unit 320-1 will be mainly described below. With regard to any non-described component of the second overpressure prevention unit 320-2, reference may be made to the description of the first overpressure prevention unit 320-1.

The first protruding portion PT1 may protrude outward from one side of the pipe 340A to define a first accommodation space SP1 that at least partially communicates with the flow path, and the second protruding portion PT2 may protrude outward from the opposite side of the pipe 340A to define a second accommodation space SP2 that at least partially communicates with the flow path. The first protruding portion PT1 and the second protruding portion PT2 may protrude in opposite directions.

The first accommodation space SP1 may include 1-1^{st} and 1-2^{nd} accommodation spaces SP11 and SP12, and the second accommodation space SP2 may include 2-1^{st} and 2-2^{nd} accommodation spaces SP21 and SP22.

The 1-1^{st} accommodation space SP11 is a space that communicates with the flow path and accommodates the first overpressure prevention member 412, and the 1-2^{nd} accommodation space SP12 is a space that is adjacent to the 1-1^{st} accommodation space SP11 and accommodates the first elastic member 414. Similarly, the 2-1^{st} accommodation space SP21 is a space that communicates with the flow path and accommodates the second overpressure prevention member 422, and the 2-2^{nd} accommodation space SP22 is a space that is adjacent to the 2-1^{st} accommodation space SP21 and accommodates the second elastic member 424. Unlike the 1-1^{st} and 2-1^{st} accommodation spaces SP11 and SP21, the 1-2^{nd} and 2-2^{nd} accommodation spaces SP12 and SP22 may not communicate with the flow path.

To this end, the first blocking portion 418 is disposed between the flow path and the 1-2^{nd} accommodation space SP12 to block the fluid from flowing into the 1-2^{nd} accommodation space SP12. In addition, the second blocking portion 428 is disposed between the flow path and the 2-2^{nd} accommodation space SP22 to block the fluid from flowing into the 2-2^{nd} accommodation space SP22.

The first blocking portion 418 may be disposed so as to extend above a third side surface S3 of the first overpressure prevention member 412 to be described later, and the second blocking portion 428 may be disposed so as to extend above a third side surface of the second overpressure prevention member 422.

Due to placement of the first and second blocking portions 418 and 428, the first and second elastic members 414 and 424 may be protected from a fluid such as coolant having high viscosity.

The first overpressure prevention member 412 may be disposed in the 1-1^{st} accommodation space SP11 to receive the hydraulic pressure of the fluid flowing through the pipe, and the second overpressure prevention member 422 may be disposed in the 2-1^{st} accommodation space SP21 to receive the hydraulic pressure of the fluid flowing through the pipe.

The first elastic member 414 is disposed in the 1-2^{nd} accommodation space SP12 to apply spring force (or elastic force) to the first overpressure prevention member 412 in a direction A2 opposite the flow direction A1 of the fluid. The second elastic member 424 is disposed in the 2-2^{nd} accommodation space SP22 to apply spring force to the second overpressure prevention member 422 in a direction opposite the flow direction of the fluid.

According to the embodiment, each of the first and second elastic members 414 and 424 may include an elastic body, a hydraulic spring, or the like.

The first elastic member 414 may have a coefficient of elasticity allowing the first elastic member 414 to be compressed by the first overpressure prevention member 412 when the hydraulic pressure is higher than a first predetermined pressure. The second elastic member 424 may have a coefficient of elasticity allowing the second elastic member 424 to be compressed by the second overpressure prevention member 422 when the hydraulic pressure is higher than the first predetermined pressure.

The first predetermined pressure is a pressure at which the components of the fuel cell may be damaged, and may be experimentally obtained in advance.

The first support member 416 serves to support the first overpressure prevention member 412. That is, the first support member 416 serves to support the first overpressure prevention member 412 so that the first overpressure prevention member 412 does not escape from the 1-1^{st} accommodation space SP11 in a state in which the first elastic member 414 is not compressed by the first overpressure prevention member 412.

The second support member 426 serves to support the second overpressure prevention member 422. That is, the second support member 426 serves to support the second overpressure prevention member 422 so that the second overpressure prevention member 422 does not escape from the 2-1^{st} accommodation space SP21 in a state in which the second elastic member 424 is not compressed by the second overpressure prevention member 422.

When the hydraulic pressure received by the first overpressure prevention member 412 is greater than the spring force of the first support member 414, at least a portion of the first overpressure prevention member 412 may move from the 1-1^{st} accommodation space SP11 to the flow path of the pipe 340A. When the hydraulic pressure received by the second overpressure prevention member 422 is greater than the spring force of the second support member 424, at least a portion of the second overpressure prevention member 422 may move from the 2-1^{st} accommodation space SP21 to the flow path of the pipe 340A. Accordingly, the area of the flow path of the pipe 340A may be reduced, whereby the pressure of the fluid may be reduced. To this end, for example, the first overpressure prevention member 412 may include first, second, and third side surfaces S1, S2, and S3.

The first side surface S2 corresponds to a surface that is in contact with the first elastic member 414.

The second side surface S1 corresponds to a surface that is opposite the first side surface S2, is in contact with the first support member 416, and receives the hydraulic pressure.

The third side surface S3 is formed between the first side surface S1 and the second side surface S2 and has an inclined cross-section.

When the first overpressure prevention member 412 is pushed toward the first elastic member 414 by the fluid, i.e., when the first elastic member 414 is compressed, the corner portion at which the second side surface S2 and the third side surface S3 meet each other may enter the flow path, thereby reducing the area of the flow path.

Similarly, the second overpressure prevention member 422 may also include first to third side surfaces and may operate in the same manner as the first overpressure prevention member 412.

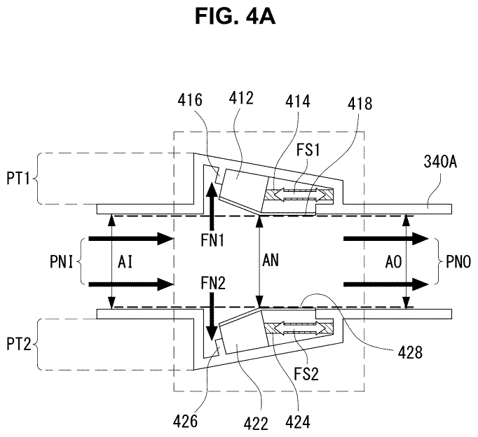

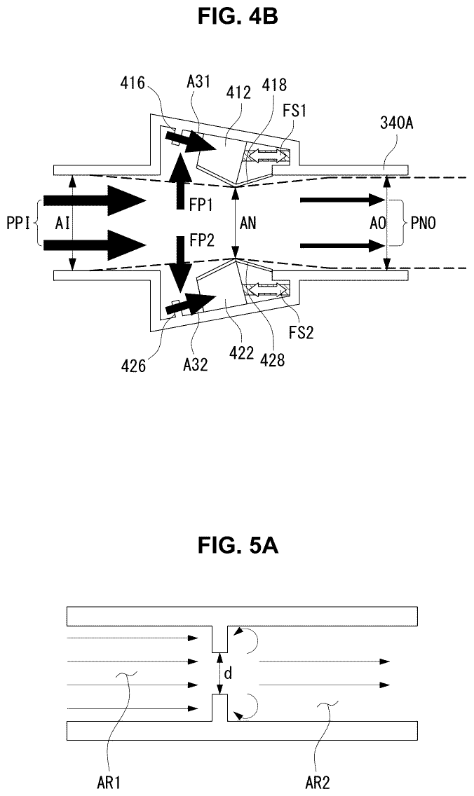

FIG. 4A is a view showing a state in which the first and second overpressure prevention members 412 and 422 are not introduced into the flow path, and FIG. 4B is a view showing a state in which the first and second overpressure prevention members 412 and 422 are introduced into the flow path.

Referring to FIG. 4A, when the pressure PNI of the fluid flowing into the pipe 340A is not high, i.e., when the pressure FN1 applied to the first overpressure prevention member 412 by the fluid having the hydraulic pressure PNI is less than or equal to the spring force FS1 with which the first elastic member 414 pushes the first overpressure prevention member 412, the first overpressure prevention member 412 does not escape from the 1-1^{st} accommodation space SP11 and is located in the 1-1^{st} accommodation space SP11. In addition, when the pressure FN2 applied to the second overpressure prevention member 422 by the fluid having the hydraulic pressure PNI is less than or equal to the spring force FS2 with which the second elastic member 424 pushes the second overpressure prevention member 422, the second overpressure prevention member 422 does not escape from the 2-1^{st} accommodation space SP21 and is located in the 2-1^{st} accommodation space SP21. Therefore, the width (or area) AI of the inlet of the pipe 340A (hereinafter referred to as the “inlet width”), the width (or area) AO of the outlet of the pipe 340A (hereinafter referred to as the “outlet width”), and the width (or area) AN of the pipe 340A between the first and second overpressure prevention units (hereinafter referred to as the “intermediate width”) are identical to each other, and thus the pressure PNO of the fluid flowing out of the pipe 340A is equal to the pressure PNI of the fluid flowing into the pipe 340A. In this way, the first and second overpressure prevention units 320-1 and 320-2 have no influence on the pressure of the fluid flowing through the pipe 340A. When the pressure of the fluid is not high, the first and second support members 416 and 426 may serve to support and guide the first and second overpressure prevention members 412 and 422 so that the first and second overpressure prevention members 412 and 422 are not pushed in a direction opposite the flow direction of the fluid by the elastic force of the first and second elastic members 414 and 424.

Referring to FIG. 4B, when the pressure PPI of the fluid flowing into the pipe 340A is high, i.e., when the pressure FP1 applied to the first overpressure prevention member 412 by the fluid having the hydraulic pressure PPI is greater than the spring force FS1 with which the first elastic member 414 pushes the first overpressure prevention member 412, the first overpressure prevention member 412 pushes and compresses the first elastic member 414 in an arrow direction A31, and at least a portion of the first overpressure prevention member 412 escapes from the 1-1^{st} accommodation space SP11 to the flow path and is located in the flow path of the pipe 340A. In addition, when the pressure FP2 applied to the second overpressure prevention member 422 by the fluid having the hydraulic pressure PPI is greater than the spring force FS2 with which the second elastic member 424 pushes the second overpressure prevention member 422, the second overpressure prevention member 422 pushes and compresses the second elastic member 424 in an arrow direction A32, and at least a portion of the second overpressure prevention member 422 escapes from the 2-1^{st} accommodation space SP21 to the flow path and is located in the flow path of the pipe 340A. That is, each of the first and second elastic members 414 and 424 may be compressed by the force F produced according to Equation 1 below.

$$F = Pressure of Fluid \times D \qquad [ Equation 1 ]$$

Here, D represents the cross-sectional area of the surface (e.g., the first side surface S1) of the first or second overpressure prevention member 412 or 422 that receives the hydraulic pressure.

According to the embodiment, the spring constants k of the first and second elastic members 414 and 424 may be determined so that the first and second elastic members 414 and 424 are compressed by the force F corresponding to the hydraulic pressure that may damage the components of the fuel cell.

In the state shown in FIG. 4B, because the width (or area) AN of the pipe 340A between the first and second overpressure prevention units (hereinafter referred to as the “intermediate width”) is less than the width (or area) AI of the inlet of the pipe 340A (hereinafter referred to as the “inlet width”) and the width (or area) AO of the outlet of the pipe 340A (hereinafter referred to as the “outlet width”), the pressure PNO of the fluid flowing out of the pipe 340A may be lower than the pressure PPI of the fluid flowing into the pipe 340A. In this way, the first and second overpressure prevention units 320-1 and 320-2 serve to reduce the pressure of the fluid flowing through the pipe 340A.

According to the embodiment, as a 1-1^{st} angle θ11 formed by the second side surface S2 and the third side surface S3 of the first overpressure prevention member 412, a 2-1^{st} angle θ21 formed by the second side surface S2 and the third side surface S3 of the second overpressure prevention member 422, a 1-2^{nd} angle θ12 formed by two inner sides of the 1-2^{nd} accommodation space SP12 in the first protruding portion PT1, and a 2-2^{nd} angle θ22 formed by two inner sides of the 2-2^{nd} accommodation space SP22 in the second protruding portion PT2 (refer to FIG. 3) increase, the intermediate size AN of the pipe 340A shown in FIG. 4A becomes much smaller than the inlet size AI of the pipe 340A, whereby the pressure of the fluid is more greatly reduced, and the flow rate of the fluid is more greatly increased. Therefore, the pressure of the fluid may be regulated by adjusting the above angles θ11, θ12, θ21, and θ22. In this case, the extent to which the pressure of the fluid is regulated may be increased when the angles are used in combination ((θ11 and θ12) or (θ21 and θ22)) compared to when only one of the angles is used ((θ11 or θ12) or (θ21 or θ22)).

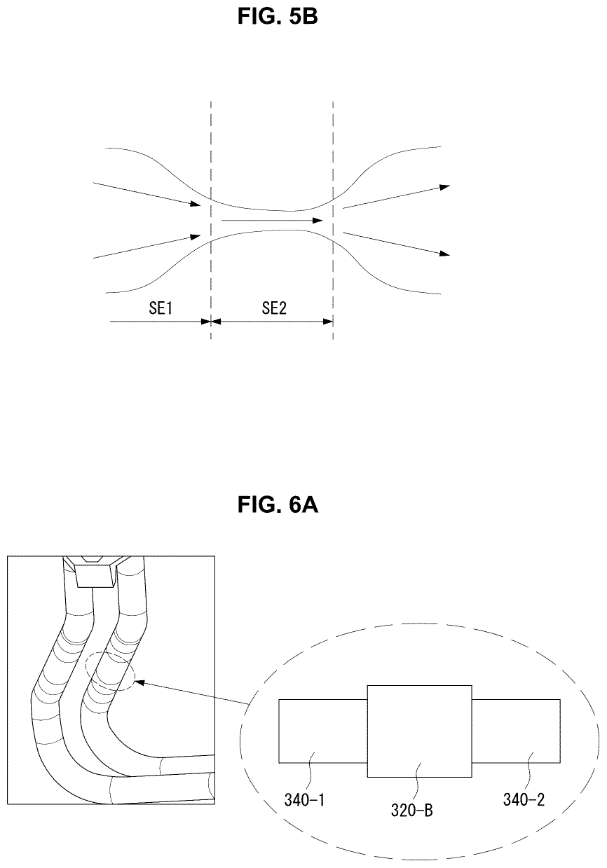

FIGS. 5A and 5B are views for explaining the principle of reduction in pressure by the overpressure prevention unit according to the embodiment.

In the orifice structure shown in FIG. 5A, when the cross-sectional area of an intermediate region between a first region AR1 and a second region AR2 is temporarily reduced, a fluid introduced into the first region AR1 is reduced in pressure and increased in flow rate after passing through an opening having a width d.

In the Venturi structure shown in FIG. 5B, when the cross-sectional area of a flow path through which a fluid passes is gradually reduced from a first section SE1 to a second section SE2, the fluid introduced into the first section SE1 is reduced in pressure and increased in flow rate after passing through the second section SE2.

According to the embodiment, the shape of the overpressure prevention unit 320 may be implemented such that the area of the flow path is reduced nonlinearly (refer to FIG. 5A) or linearly (refer to FIG. 5B) in proportion to the hydraulic pressure received by the overpressure prevention unit 320. If the overpressure prevention unit 320 is implemented as shown in FIG. 3, the area of the flow path may be reduced more linearly than in the case shown in FIG. 5A and more nonlinearly than in the case shown in FIG. 5B in proportion to the hydraulic pressure received by the overpressure prevention unit 320.

Based on the principle described above with reference to FIGS. 5A and 5B, it can be seen that, as in the embodiment shown in FIG. 4B, when the first and second overpressure prevention members 412 and 422 enter the flow path due to the hydraulic pressures FP1 and FP2, the cross-sectional area of the flow path is reduced and thus the pressure of the fluid is reduced.

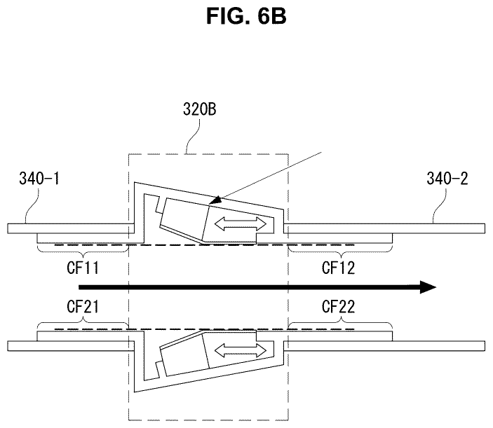

FIGS. 6A and 6B are views for explaining an application example of the overpressure prevention unit according to the embodiment.

As shown in FIGS. 6A and 6B, a plurality of separate pipes 340-1 and 340-2 may be connected to each other through an overpressure prevention unit 320B.

To this end, the overpressure prevention unit 320B is disposed between the plurality of pipes 340-1 and 340-2 to interconnect the plurality of pipes 340-1 and 340-2.

Here, the overpressure prevention unit 320B may have the same configuration as the overpressure prevention unit 320A described above. However, the first overpressure prevention unit of the overpressure prevention unit 320B may further include 1-1^{st} and 1-2^{nd} connection frames CF11 and CF12, and the second overpressure prevention unit of the overpressure prevention unit 320B may further include 2-1^{st} and 2-2^{nd} connection frames CF21 and CF22. The 1-1^{st} and 2-1^{st} connection frames CF11 and CF21 may be disposed in one (e.g., 340-1) of the plurality of pipes 340-1 and 340-2, and the 1-2^{nd} and 2-2^{nd} connection frames CF12 and CF22 may be disposed in the other (e.g., 340-2) of the plurality of pipes 340-1 and 340-2.

If hydrogen, air, or coolant is instantaneously supplied to the flow path in the fuel cell at a high pressure, the overpressure prevention unit using the principle of an orifice and the Venturi effect may reduce the excessive pressure of the fluid and increase the flow rate of the fluid, thereby improving cell performance (i.e., cell reaction) and preventing degradation.

In the conventional fuel cell, a pipe (or hose) extension bracket is used to interconnect a plurality of separate pipes. On the other hand, according to the embodiment, as shown in FIGS. 6A and 6B, the overpressure prevention unit may play the role of the extension bracket, and thus it is not necessary to use a separate extension bracket.

As is apparent from the above description, according to a fuel cell according to the embodiment, when hydrogen, air, or coolant is instantaneously supplied at a high pressure, the excessive pressure of the fluid may be reduced and the flow rate of the fluid may be increased by an overpressure prevention unit. As a result, cell performance (i.e., cell reaction) may be improved, and degradation may be prevented. Further, because the overpressure prevention unit plays the role of an extension bracket, it is not necessary to use a separate extension bracket.

However, the effects achievable through the disclosure are not limited to the above-mentioned effects, and other effects not mentioned herein will be clearly understood by those skilled in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell comprising:
a cell stack configured to generate electric power from electrochemical reactions;
a fluid management unit configured to supply a fluid to the cell stack;
a conduit defining a flow path for the fluid between the fluid management unit and the cell stack; and
an overpressure prevention unit disposed in the pipe and configured to regulate a cross-sectional area of the flow path in response to a hydraulic pressure of the fluid.

2. The fuel cell of claim 1, wherein the overpressure prevention unit comprises:
a protruding portion extending outward from the conduit and defining an accommodation space in fluid communication with the flow path,
an overpressure prevention member movably disposed within the accommodation space,
a support member configured to retain the overpressure prevention member in the accommodation space unless displaced by a predetermined fluid pressure, and
an elastic member biased against the overpressure prevention member in a direction opposite the fluid flow,
such that when the fluid pressure exceeds the biasing force of the elastic member, at least part of the overpressure prevention member moves into the flow path to reduce the cross-sectional area.

3. The fuel cell according to claim 2, wherein the overpressure prevention member includes:
a first side surface being in contact with the support member, the first side surface receiving the hydraulic pressure;
a second side surface formed opposite the first side surface, the second side surface formed to be in contact with the elastic member; and
a third side surface formed between the first side surface and the second side surface, the third side surface having an inclined cross-section, and
wherein, when the overpressure prevention member is pushed toward the elastic member by the fluid, a corner portion at which the second side surface and the third side surface meet each other enters the flow path, thereby reducing the cross-sectional area of the flow path.

4. The fuel cell according to claim 1, wherein the fluid management unit includes:
an air processing system configured to manage inflow and outflow of air into and from the cell stack;
a fuel processing system configured to manage inflow and outflow of hydrogen into and from the cell stack; and
a thermal management system configured to manage inflow and outflow of a cooling medium into and from the cell stack, and
wherein the conduit includes:
an air conduit disposed between the air processing system and the cell stack;
a hydrogen conduit disposed between the fuel processing system and the cell stack; and
a cooling conduit disposed between the thermal management system and the cell stack.

5. The fuel cell according to claim 4, wherein the overpressure prevention unit is disposed in at least one of the air conduit, the hydrogen conduit, or the cooling conduit.

6. The fuel cell according to claim 1, wherein the conduit includes a plurality of separate conduits, and
wherein the overpressure prevention unit is disposed between the plurality of separate conduits to interconnect the plurality of separate conduits.

7. The fuel cell according to claim 1, wherein the overpressure prevention unit includes first and second overpressure prevention units disposed opposite each other with the flow path interposed therebetween in a direction intersecting a flow direction of the fluid.

8. The fuel cell according to claim 7, wherein the first and second overpressure prevention units have cross-sectional shapes symmetrical to each other with respect to the flow path.

9. The fuel cell according to claim 2, wherein the elastic member has an elasticity allowing the elastic member to be compressed by the overpressure prevention member when the hydraulic pressure is higher than a first predetermined pressure.

10. The fuel cell according to claim 2, wherein the overpressure prevention member linearly reduces the cross-sectional area of the flow path in proportion to the hydraulic pressure received thereby.

11. The fuel cell according to claim 2, wherein the overpressure prevention member nonlinearly reduces the cross-sectional area of the flow path in proportion to the hydraulic pressure received thereby.

12. The fuel cell according to claim 2, wherein the accommodation space includes:
a first accommodation space communicating with the flow path and accommodating the overpressure prevention member; and
a second accommodation space neighboring the first accommodation space and accommodating the elastic member.

13. The fuel cell according to claim 12, further comprising a blocking portion disposed between the flow path and the second accommodation space to block the fluid from flowing into the second accommodation space.

14. A fuel cell system comprising:
a cell stack configured to generate electric power from electrochemical reactions,
a fluid management unit configured to supply at least one fluid to the cell stack,
a first fluid conduit and a second fluid conduit arranged to direct the at least one fluid, and
an extension bracket fluidly coupling the first fluid conduit to the second fluid conduit,
wherein the extension bracket integrates an overpressure prevention structure including:
an overpressure prevention member configured to protrude into a flow path through the bracket in response to fluid pressure exceeding a predetermined threshold, and
an elastic member applying a biasing force that retains the overpressure prevention member outside the flow path during normal operating pressure.

15. The fuel cell system of claim 14, wherein the extension bracket replaces a hose bracket, thereby reducing the need for a separate bracket to connect the first fluid conduit and the second fluid conduit.

16. The fuel cell system of claim 14, wherein the overpressure prevention structure further comprises a guide portion configured to restrain the overpressure prevention member from inadvertently shifting into the flow path when fluid pressure is below the predetermined threshold.

17. The fuel cell system of claim 14, wherein the overpressure prevention structure is configured to be applicable to any one or more of hydrogen flow, air flow, or coolant flow within the fuel cell system.

18. The fuel cell system of claim 14, further comprising a vehicle body, wherein the cell stack is mounted on the vehicle body and the extension bracket is disposed along at least one fluid line supplying the cell stack within the vehicle.

19. A method of preventing overpressure in a fuel cell system, comprising:
disposing, between a fluid management unit and a cell stack, an overpressure prevention unit having an overpressure prevention member and an elastic member arranged in an extension bracket that interconnects two fluid conduits;
maintaining the overpressure prevention member out of a fluid flow path when fluid pressure is below a predetermined threshold; and
automatically reducing a cross-sectional area of the fluid flow path by allowing the overpressure prevention member to protrude into the flow path when the fluid pressure exceeds the predetermined threshold.

20. The method of claim 19, further comprising selecting a spring constant for the elastic member based on the predetermined threshold, wherein the overpressure prevention member remains fully retracted during normal operating conditions and only protrudes into the flow path upon detecting the predetermined overpressure condition.
